(19) United States
(12) Patent Application Publication
(10) Pub. No.: US 2009/0221455 A1
(43) Pub. Date: Sep. 3, 2009

(54) METHODS AND COMPOSITIONS FOR PROTECTING STEELS IN ACIDIC SOLUTIONS

(76) Inventors: Mingjie Ke, Spring, TX (US); Qi Qu, Spring, TX (US); Joel L. Boles, Spring, TX (US)

Correspondence Address: HOWREY LLP, C/O IP DOCKETING DEPARTMENT, 2941 FAIRVIEW PARK DRIVE , Suite 200, FALLS CHURCH, VA, 22042, US

(21) Appl. No.: 12/040,427

(22) Filed: Feb. 29, 2008

(51) Int. Cl. C09K 8/54

(52) U.S. Cl. 507/261

(57) ABSTRACT

An acid treatment composition is provided including a corrosion inhibitor and an optional corrosion inhibitor intensifier in an acidic solution. More specifically, the composition includes a propargylalcohol alkoxylated compound. Methods for treating wells with these acid treatment compositions are also provided that help control corrosion of the steel used in the wells during the acid treatment.

### BACKGROUND OF THE INVENTION

1. Field of the Invention

The present invention relates generally to the reduction of corrosion of metal alloys used during acidizing treatments of wells.

2. Description of the Related Art

Aqueous acidic solutions are frequently applied to treat wells and to remove formation damage during well completions or subsequent workovers. Acid treatment of a well involves the pumping downhole of an aqueous acidic solution that reacts with the subterranean formations, such formations usually consisting of limestone or sand, to increase the size of the pores within the formations and provide enlarged passageways for hydrocarbon, water, or steam to more freely move to collection points that would otherwise be obstructed. Depending on the types of treatments and the nature of formation damage, the aqueous acidic solutions can be hydrochloric acid (HCl), hydrochloric-hydrofluoric mud acid (HCl—HF), organic acids such as acetic acid and formic acid, or combinations thereof. A problem associated with acid treatments is the corrosion by the acidic solution of the metal tubular goods in the wellbore and the other equipment used to carry out the treatment. The corrosion problem is exacerbated by the elevated temperatures and pressures encountered in deeper formations. In the wellbore, the tubular materials used are normally carbon steel or alloy steel. The cost of repairing or replacing corrosion-damaged casing, tubing, and other equipment in the wellbore is extremely high.

Various acid compositions that include corrosion inhibitors for diminishing the corrosive effects of the acid on metal surfaces have been developed and used previously. The types of components employed in corrosion inhibitors vary depending upon the nature of the compositions, the types of metal surfaces involved, associated environmental conditions, and so forth. In some prior attempts to reduce corrosion by using corrosion inhibitors, various problems exist, such as having high toxicity ratings or not being environmentally friendly. Some prior art corrosion inhibitors are also cationic, which makes them incompatible with various other acid treatment additives, such as with anti-sludge agents.

A need exists for new and useful compositions for inhibiting or preventing corrosion during the acid treatments of wells at relatively high downhole temperatures with safer, less toxic, and more environmentally acceptable acid treatment fluid compositions. It is also desirable for the compositions to be compatible with other additives that are used in acid treatments.

### SUMMARY OF THE INVENTION

In view of the foregoing, the present invention provides methods and compositions useful for protecting metal tubular and equipment utilizing an effective corrosion inhibitor and optional corrosion inhibitor intensifier in aqueous acidic solutions. More specifically, a method of treating an alloy surface is provided as an embodiment of the present invention. The treatment fluid, which includes an aqueous acidic fluid, a corrosion inhibitor, and optionally a corrosion inhibitor intensifier for elevated temperatures, is contacted with the alloy surface. The corrosion inhibitor comprises a propargylalcohol alkoxylated compound. At elevated temperatures, the performance of the corrosion inhibitor can be increased by adding the corrosion inhibitor intensifier. The use of the combined corrosion inhibitor and the optional corrosion inhibitor intensifier substantially reduces the amount of corrosion experienced by the alloy surface compared to using the same acidic fluid without the corrosion inhibitor alone or in combination with the corrosion inhibitor intensifier. In an aspect, the method of treating the alloy surface can be used in applications before the formation or within the formation.

As another embodiment of the present invention, a method of inhibiting corrosion of a steel surface in contact with an acidic fluid is provided. In this embodiment, a corrosion inhibitor is introduced into the acidic fluid. The corrosion inhibitor comprises a compound having a formula: R—C≡C—C(R₁)(R₂)—O—[C(R₃)—C—O]ₙH, wherein R, R₁, R₂, and R₃ have from 0 to 8 carbon atoms and n ranges from 1 to 15. A corrosion inhibitor intensifier can also be included along with the corrosion inhibitor to boost the corrosion prevention power of the corrosion inhibitor, particularly at elevated temperatures. The steel surface is then contacted with the acidic fluid, along with the corrosion inhibitor and optional corrosion inhibitor intensifier. As with the other method embodiments described herein, the corrosion rate of the steel surface is substantially reduced when the corrosion inhibitor, alone or combination with the corrosion inhibitor intensifier, is added to the acidic fluid, particularly when compared with using the acidic fluid alone.

In addition to the method embodiments included herein, a composition for use in the acid treatment of wells is provided as another embodiment of the present invention. The wells can be hydrocarbon wells or non-hydrocarbon wells, such as water injection wells, water-producing wells and geothermal wells. In this embodiment, the composition includes a corrosion inhibitor comprising a propargylalcohol alkoxylated compound and an optional corrosion inhibitor intensifier in an acidic solution. As with the other embodiments described herein, the compositions of the present invention substantially reduce the amount of corrosion that occurs on a surface of a metal alloy when compared with acid treatments without the use of the compositions described herein.

### DESCRIPTION OF ILLUSTRATIVE EMBODIMENTS

Illustrative embodiments of the invention are described below as they might be employed in the operation and in the treatment of well bores. In the interest of clarity, not all features of an actual implementation are described in this specification. It will of course be appreciated that in the development of any such actual embodiment, numerous implementation-specific decisions must be made to achieve the developers' specific goals, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments of the invention will become apparent from consideration of the following description.

The present invention relates to methods and compositions for protecting metal tubular and equipment utilizing an effective corrosion inhibitor and optional corrosion inhibitor intensifier in aqueous acidic solutions. A method of treating an alloy surface is provided as an embodiment of the present invention. The treatment fluid contacts the alloy surface. The treatment fluid comprises an aqueous acidic fluid, a corrosion inhibitor comprising a propargylalcohol alkoxylated compound, and optionally a corrosion inhibitor intensifier. In an aspect, the propargylalcohol alkoxylated compound comprises prop-2-yn-1-ol alkoxylated, ethyleneglycolpropargylether, or combinations thereof. The use of the corrosion inhibitor and the optional corrosion inhibitor intensifier substantially reduces the amount of corrosion experienced by the alloy surface compared to using the same acidic fluid without the corrosion inhibitor and optional corrosion inhibitor intensifier. During treatments, a corrosion inhibitor can be added to an acid to protect tubular goods and metal equipment. For treatments at high temperatures as well as for extended acid exposure times, a corrosion inhibitor intensifier, along with the corrosion inhibitor, can be utilized to reduce corrosion of metal materials in acids. Embodiments of the present invention can be used in applications having alloy surfaces that are used in or before the wellbore or in treatments that enter into the formations.

The corrosion inhibitor of the present invention is a composition that includes a propargylalcohol alkoxylated compound, such as prop-2-yn-1-ol alkoxylated (sometimes referred to herein as “corrosion inhibitor A”), ethyleneglycolpropargylether (sometimes referred to herein as “corrosion inhibitor B”), or both. When corrosion inhibitor A or B is used, the corrosion inhibitor A or B, alone or in combination, can effectively inhibit acid corrosion of various alloy materials, such as carbon steel or alloy steel. At higher temperatures, the present corrosion inhibitor along with a corrosion inhibitor intensifier can protect various types of materials against corrosion.

In an aspect, the methods and compositions of the present invention provide a novel solution for effectively preventing corrosion during the acid treatment of wells, particularly at high temperatures. The wells can be hydrocarbon wells, such as gas or oil wells, or non-hydrocarbon wells, such as water injection wells, water producing wells, or geothermal wells. In such applications, the treatment provides enlarged passageways for hydrocarbons, water, or steam to move to collection points that would otherwise be obstructed.

The methods and compositions described herein can be used in a wide variety of temperatures. In an aspect, for example, the corrosion inhibitor comprising a propargylalcohol alkoxylated compound can be used in temperatures of up to about 225° F. For temperatures above 225° F., the corrosion inhibitor intensifier increases the corrosion prevention strength of the corrosion inhibitor. For temperatures that range from about 225° F. to about 350° F., the treatment fluid comprises the corrosion inhibitor and the corrosion inhibitor intensifier. The methods and compositions comprising both the corrosion inhibitor and the corrosion inhibitor intensifier are suitable for applications of up to about 350° F.

In embodiments of the present invention, the corrosion inhibitor intensifier can be used to help bolster the corrosion prevention power of the corrosion inhibitor on its own, particularly at elevated temperatures. In an aspect, when the corrosion inhibitor intensifier is used, the corrosion inhibitor intensifier can include formic acid, sodium formate, potassium formate, methylformate, ethylformate, sodium iodide, potassium iodide, copper iodide, molecular iodide, metal oxides, or combinations thereof. Other suitable corrosion inhibitor intensifiers will be apparent to those of skill in the art and are to be considered within the scope of the present invention.

Corrosion is a problem for many types of alloy surfaces that are exposed to aqueous acidic solutions. The methods and compositions described herein are useful in reducing corrosion rates of various types of alloy surfaces. For example, the alloy surface can include alloys of steel, alloys of nickel, coiled tubing, corrosion resistant alloys, or duplex steels. Alloys of steel can include stainless steel, carbon steel, and the like. Corrosion resistant alloys can include chromium and the like. Other suitable types of alloy surfaces that the methods and compositions described herein can be used on will be apparent to those of skill in the art and are to be considered within the scope of the present invention.

The methods and compositions described herein can be used for various types of treatments for applications that occur in or before the wellbore and in subterranean formation applications. For example, the methods and compositions of the present invention can be used in the wellbore applications or before the wellbore applications that include pickling a tubular, cleaning a wellbore, scale treatment, and coiled tubing applications. As another example, the method of treating a subterranean formation can include matrix acid stimulation, acid fracturing, acid tunneling, drilling mud removal, scale treatment, coiled tubing application, or damage removal. Regardless of the type of application, a goal of the present invention is to protect metal tubulars or alloy surfaces from the acidic fluids that are introduced into the metal tubulars or coiled tubing. Other types of treatment applications that the methods and compositions described herein can be used will be apparent to those of skill in the art and are to be considered within the scope of the present invention.

During various treatments for applications that occur before or in the wellbore and subterranean formation applications, various types of acids can be used in the aqueous acidic fluids. The methods and compositions described herein can be used with various types of aqueous acidic fluids. For example, the aqueous acidic fluid can include hydrochloric acid, hydrochloric-hydrofluoric acid, acetic acid, formic acid, citric acid, phosphonic acid, methanesulfonic acid, or combinations thereof. Other types of acids that can be used in the aqueous acidic fluids of the present invention will be apparent to those of skill in the art and are to be considered within the scope of the present invention.

The methods and compositions described herein are useful in reducing corrosion rates of metal alloy surfaces. In an aspect, the corrosion inhibitor and corrosion inhibitor intensifier reduce corrosion rates of the alloy surface to less than about 0.050 lb/ft² for regular tubular or 0.02 lb/ft² for coiled tubing during the step of contacting the alloy surface with the treatment fluid. The methods and compositions described herein are also useful in temperatures of up to about 350° F.

As another embodiment of the present invention, a method of inhibiting corrosion of a steel surface in contact with an acidic fluid is provided. In this embodiment, the acidic fluid is contacted with an optional corrosion inhibitor intensifier and a corrosion inhibitor comprising a compound having a formula as follows:

R—C≡C—C(R₁)(R₂)—O—[C(R₃)—C—O]ₙH

wherein R, R₁, R₂, and R₃ have from 0 to 8 carbon atoms and n ranges from 1 to 15. The steel surface is then contacted with the acidic fluid, along with the corrosion inhibitor and optional corrosion inhibitor intensifier. In an aspect, the corrosion inhibitor is a propargylalcohol alkoxylated compound. In an aspect, the propargylalcohol alkoxylated compound is prop-2-yn-1-ol alkoxylated, ethyleneglycolpropargylether, or combinations thereof. As with the other method embodiments described herein, the corrosion rate of the steel surface is substantially reduced when the corrosion inhibitor and the optional corrosion inhibitor intensifier are added to the acidic fluid, particularly when compared with using the acidic fluid alone.

Besides the methods described herein, a composition for use in the acid treatment of wells is also provided as another embodiment of the present invention. In this embodiment, a corrosion inhibitor comprising a propargylalcohol alkoxylated compound and an optional corrosion inhibitor intensifier are contacted in an acidic solution. In an aspect, the propargylalcohol alkoxylated compound can be prop-2-yn-1-ol alkoxylated, ethyleneglycolpropargylether, or combinations thereof. As with the other embodiments described herein, the compositions of the present invention substantially reduce the amount of corrosion that occurs on a surface of a metal alloy when compared with acid treatments without the use of the compositions described herein.

In embodiments of the present invention, the compositions used in the acid treatment of wells comprise about 0.1 vol. % to about 5.0 vol. % corrosion inhibitor in the acidic solution; alternatively, from about 0.5 vol. % to about 2.0 vol. %; or alternatively, from about 0.5 vol. % to about 1.5 vol. %. When the corrosion inhibitor intensifier is added to the composition, the composition can comprise about 2 pounds per thousand gallons (pptg) to about 100 pptg corrosion inhibitor intensifier; or alternatively, from about 5 pptg to about 35 pptg. In an aspect, when a liquid corrosion inhibitor intensifier is added to the composition, the composition can comprise about 1 gallon per thousand gallons (gpt) to about 50 gpt; alternatively, from about 5 gpt to about 30 gpt; or alternatively, from about 5 gpt to about 10 gpt. The amount of acid that can be used in the acid treatment varies, as will be apparent to those of skill in the art. Various amounts of acids contained within the compositions described herein can be used in the present invention. In an aspect, the composition can comprise from about 1 wt. % to about 50 wt. % acid in the acidic fluid; alternatively, from about 3 wt. % to about 30 wt. % acid in the acidic fluid; or alternatively, about 15 wt. % acid in the acidic fluid.

Similar to the method embodiments, the corrosion inhibitor intensifier can include formic acid, sodium formate, potassium formate, methylformate, ethylformate, sodium iodide, potassium iodide, copper iodide, molecular iodide, metal oxides, or combinations thereof. The acidic solution can include hydrochloric acid, hydrochloric-hydrofluoric acid, acetic acid, formic acid, citric acid, phosphonic acid, methanesulfonic acid, and combinations thereof.

Besides the compositions described herein, other components commonly used in acidizing compositions can be used to broaden the range of applications in which the methods and compositions of the present invention can be used, so long as the components are compatible with the methods and compositions described herein. For example, mutual solvents or alcohols (such as methanol or isopropanol), surfactants, iron control agents, non-emulsifiers, foaming agents, water-wetting surfactants, anti-sludge agents, gelling agents, bactericides, clay stabilizer or fluid loss control agents, and the like can be used in the present invention. The amount of such additives, when employed, is typically between from about 0.1 to about 2 weight percent. When mutual solvent or alcohols are employed, they are typically used in amounts between from about 1 to about 20 weight percent of the well treatment composition. Other suitable compatible components and amounts will be apparent to those of skill in the art and are to be considered within the scope of the present invention.

As an advantage of the present invention, the new corrosion inhibitors and corrosion inhibitor intensifiers in the present invention have low toxicity and are biodegradable. They can replace some conventional corrosion inhibitors that are less environmentally friendly. The compositions of the present invention also provide a novel solution for effectively reducing the toxicity and environmental impact of many acid well stimulation treatment fluids, such as those that use hydrochloric acid. As yet another advantage, due to their non-ionic characteristics, the corrosion inhibitors in the current invention can be applied in such environments where the use of cationic acid corrosion inhibitors can cause an incompatibility problem with some acid additives, such as anti-sludging agent.

The following examples are included to demonstrate the use of compositions in accordance with embodiments of the present invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the scope of the invention.

### EXAMPLES

### Example 1

Corrosion tests were performed at 180° F. and 257° F. on two different types of steel, carbon steel (C4130) and 13% chromium steel (13Cr). The results of the corrosion tests are shown in Table 1. A 15 wt. % hydrochloric acid solution was applied to the two different types of steel for four hours. Two comparison runs were performed at 180° F. (Sample Nos. 1 and 8) where only the aqueous acidic fluid was used, without any corrosion inhibitor or corrosion inhibitor intensifier. At 180° F., only one of the corrosion inhibitors was used (A or B), while at 257° F., the corrosion inhibitor (A or B) and the corrosion inhibitor intensifier were used together.

As demonstrated by Table 1, by applying the compositions and using the methods described herein, corrosion of various types of metals, such as carbon steel and alloy steel, in aqueous acidic solutions can be controlled. The results in Table 1 demonstrate the effectiveness of the corrosion inhibitors in the current invention and the synergistic effect achieved on corrosion inhibition when the corrosion inhibitor intensifier of the present invention is utilized. The industry acceptable level for corrosion rates is less than 0.050 lb/ft² during the life of treatment, i.e., acid contact time. As can be seen from Table 1, all of the samples that used either the corrosion inhibitor alone at lower temperatures or in combination with the corrosion inhibitor at higher temperatures performed substantially better than the samples without any corrosion inhibitor and corrosion inhibitor intensifier and also substantially better than the acceptable industry standard of less than 0.050 lb/ft² for regular tubular.

TABLE 1

| | | | Loadings of Corrosion Inhibitor | |
|---|---|---|---|---|
| Sample | | Temperature | and Corrosion Inhibitor | Corrosion |
| No. | Metal Type | (° F.) | Intensifier | Rates, lb/ft² |
| 1 | C4130 | 180 | None | 0.162 |
| 2 | C4130 | 180 | 0.6 vol % Corrosion Inhibitor A | 0.003 |
| 3 | C4130 | 180 | 0.6 vol % Corrosion Inhibitor B | 0.004 |
| 4 | C4130 | 257 | 1 vol % Corrosion Inhibitor A + 10 pptg | 0.017 |
| | | | potassium iodide | |
| 5 | C4130 | 257 | 1 vol % Corrosion Inhibitor A + 10 gpt | 0.019 |
| | | | copper iodide solution | |
| 6 | C4130 | 257 | 1 vol % Corrosion Inhibitor B + 10 pptg | 0.016 |
| | | | potassium iodide | |
| 7 | C4130 | 257 | 1 vol % Corrosion Inhibitor B + 10 gpt | 0.017 |
| | | | copper iodide solution | |
| 8 | 13Cr | 180 | None | 0.685 |
| 9 | 13Cr | 180 | 0.6 vol % Corrosion Inhibitor A | 0.006 |
| 10 | 13Cr | 180 | 0.6 vol % Corrosion Inhibitor B | 0.004 |
| 11 | 13Cr | 257 | 1 vol % Corrosion Inhibitor A + 30 pptg | 0.021 |
| | | | potassium iodide | |
| 12 | 13Cr | 257 | 1 vol % Corrosion Inhibitor B + 10 pptg | 0.023 |
| | | | potassium iodide | |
| 13 | 13Cr | 257 | 1 vol % Corrosion Inhibitor B + 30 pptg | 0.015 |
| | | | potassium iodide | |
| 14 | 13Cr | 257 | 1 vol % Corrosion Inhibitor B + 10 gpt | 0.020 |
| | | | copper iodide solution | |

### Example 2

Corrosion tests were performed at 250° F. on two different types of steel, carbon steel (N-80 carbon steel) and coiled tubing (QT800 coiled tubing). The results of the corrosion tests are shown in Table 2. The acid solution was applied to the two different types of steel for sixteen hours.

As demonstrated by Table 2, by applying the compositions and using the methods described herein, corrosion of various types of metals, such as carbon steel and coiled tubing, in aqueous acidic solutions can be controlled. The results in Table 2 demonstrate the effectiveness of the corrosion inhibitors in the current invention and the synergistic effect achieved on corrosion inhibition when the corrosion inhibitor intensifier of the present invention is utilized. The industry acceptable level for corrosion rates is less than 0.050 lb/ft² during the life of treatment, i.e., acid contact time, for regular tubular and less than 0.020 lb/ft² for coiled tubing.

TABLE 2
16-hour Acid Corrosion Tests at 250° F.

| | | | Loadings of Corrosion Inhibitor | Corrosion |
|---|---|---|---|---|
| Sample | | | and Corrosion Inhibitor | Rates, |
| No. | Metal Type | Type of Acid | Intensifier | lb/ft² |
| 1 | N-80 carbon | 9% HCl:1% HF | 3 vol % Corrosion Inhibitor A + 30 pptg | 0.027 |
| | steel | | potassium iodide | |
| 2 | N-80 carbon | 9% HCl:1% HF | 3 vol % Corrosion Inhibitor B + 30 pptg | 0.014 |
| | steel | | potassium iodide | |
| 3 | N-80 carbon | 15% HCl | 2 vol % Corrosion Inhibitor B + 30 pptg | 0.045 |
| | steel | | potassium iodide | |
| 4 | N-80 carbon | 15% HCl | 3 vol % Corrosion Inhibitor B + 30 pptg | 0.032 |
| | steel | | potassium iodide | |
| 5 | QT800 coiled | 15% HCl | 3 vol % Corrosion Inhibitor A + 30 gpt | 0.016 |
| | tubing | | copper iodide solution | |
| 6 | QT800 coiled | 15% HCl | 3 vol % Corrosion Inhibitor B + 30 pptg | 0.013 |
| | tubing | | potassium iodide | |

All of the compositions and/or methods disclosed and claimed herein can be made and executed without undue experimentation in light of the present disclosure. While the compositions and methods of this invention have been described in terms of preferred embodiments, it will be apparent to those of skill in the art that variations can be applied to the compositions and/or methods and in the steps or in the sequence of steps of the methods described herein without departing from the concept, spirit and scope of the invention. More specifically, it will be apparent that certain agents that are chemically related can be substituted for the agents described herein while the same or similar results would be achieved. All such similar substitutes and modifications apparent to those skilled in the art are deemed to be within the scope and concept of the invention.

What is claimed is:

1. A method of treating an alloy surface comprising the step of contacting the alloy surface with a treatment fluid comprising an aqueous acidic fluid and a corrosion inhibitor comprising a propargylalcohol alkoxylated compound so that a reduction in corrosion of the alloy surface occurs compared with only contacting the alloy surface with the aqueous acidic fluid.

2. The method of claim 1, wherein the propargylalcohol alkoxylated compound comprises prop-2-yn-1-ol alkoxylated, ethyleneglycolpropargylether, or combinations thereof.

3. The method of claim 1, wherein the alloy surface comprises alloys of steel, alloys of nickel, coiled tubing, corrosion resistant alloys, or duplex steels.

4. The method of claim 1, wherein the alloy surface is used in an application comprising pickling a tubular, cleaning a wellbore, matrix acid stimulation, acid fracturing, acid tunneling, drilling mud removal, scale treatment, coiled tubing application, or damage removal.

5. The method of claim 1, wherein the aqueous acidic fluid comprises hydrochloric acid, hydrochloric-hydrofluoric acid, acetic acid, formic acid, citric acid, phosphonic acid, methanesulfonic acid, or combinations thereof.

6. The method of claim 1, wherein the corrosion inhibitor is present in a range of about 0.1 vol. % to about 5.0 vol. % and the corrosion inhibitor reduces corrosion rates of the alloy surface to less than about 0.050 lb/ft² during the step of contacting the alloy surface with the treatment fluid.

7. The method of claim 1, wherein the treatment fluid further comprises a corrosion inhibitor intensifier comprising formic acid, sodium formate, potassium formate, methylformate, ethylformate, sodium iodide, potassium iodide, copper iodide, molecular iodide, metal oxides, or combinations thereof.

8. The method of claim 7, wherein the corrosion inhibitor intensifier is present in a range of about 2 pptg to about 100 pptg and the corrosion inhibitor and corrosion inhibitor intensifier reduce corrosion rates of the alloy surface to less than about 0.050 lb/ft² during the step of contacting the alloy surface with the treatment fluid at temperatures of up to about 350° F.

9. The method of claim 7, wherein the corrosion inhibitor intensifier is liquid and is present in a range of about 1 gpt to about 50 gpt.

10. A method of inhibiting corrosion of a steel surface in contact with an acidic fluid comprising the steps of:
a. contacting the acidic fluid with a corrosion inhibitor comprising a compound having a formula
R—C≡C—C(R₁)(R₂)—O—[C(R₃)—C—O]ₙH
wherein R, R₁, R₂, and R₃ have from 0 to 8 carbon atoms and n ranges from 1 to 15; and
b. contacting the steel surface with the acidic fluid and the corrosion inhibitor.

11. The method of claim 10, wherein the corrosion inhibitor is a propargylalcohol alkoxylated compound comprising prop-2-yn-1-ol alkoxylated, ethyleneglycolpropargylether, or combinations thereof and is present in a range of about 0.1 vol. % to about 5.0 vol. %.

12. The method of claim 10, wherein the steel surface comprises alloys of steel, alloys of nickel, coiled tubing, corrosion resistant alloys, or duplex steels.

13. The method of claim 10, wherein the step of contacting the steel surface with the acidic fluid and the corrosion inhibitor comprises pickling a tubular, cleaning a wellbore, matrix acid stimulation, acid fracturing, acid tunneling, drilling mud removal, scale treatment, coiled tubing application, or damage removal.

14. The method of claim 10, wherein the acidic fluid comprises hydrochloric acid, hydrochloric-hydrofluoric acid, acetic acid, formic acid, citric acid, phosphonic acid, methanesulfonic acid, and combinations thereof.

15. The method of claim 10, wherein the corrosion inhibitor reduces corrosion rates of the steel surface to less than about 0.050 lb/ft² during the step of contacting the steel surface with the acidic fluid.

16. The method of claim 10, wherein the acidic fluid is also contacted with a corrosion inhibitor intensifier along with the corrosion inhibitor, the corrosion inhibitor intensifier comprising formic acid, sodium formate, potassium formate, methylformate, ethylformate, sodium iodide, potassium iodide, copper iodide, molecular iodide, metal oxides, or combinations thereof.

17. The method of claim 16, wherein the corrosion inhibitor intensifier is present in a range of about 2 pptg to about 100 pptg and wherein the corrosion inhibitor and corrosion inhibitor intensifier reduce corrosion rates of the alloy surface to less than about 0.050 lb/ft² during the step of contacting the steel surface with the acidic fluid at temperatures of up to about 350° F.

18. The method of claim 16, wherein the corrosion inhibitor intensifier is liquid and is present in a range of about 1 gpt to about 50 gpt.

19. A composition for use in the acid treatment of wells, comprising:
a corrosion inhibitor comprising a propargylalcohol alkoxylated compound and a corrosion inhibitor intensifier in an acidic solution.

20. The composition of claim 19, wherein the propargylalcohol alkoxylated compound comprises prop-2-yn-1-ol alkoxylated, ethyleneglycolpropargylether, or combinations thereof; the corrosion inhibitor intensifier comprises formic acid, sodium formate, potassium formate, methylformate, ethylformate, sodium iodide, potassium iodide, copper iodide, molecular iodide, metal oxides, or combinations thereof; and the acidic solution comprises hydrochloric acid, hydrochloric-hydrofluoric acid, acetic acid, formic acid, citric acid, phosphonic acid, methanesulfonic acid, and combinations thereof.
